(19) United States
(12) Patent Application Publication
(10) Pub. No.: US 2026/0099352 A1
(43) Pub. Date: Apr. 9, 2026

(54) COGNITIVE KERMEL: A DOCKERIZED "AUTOPILOT" SYSTEM THAT EVERYONE CAN DEPLOY PRIVATELY

(71) Applicant: Tencent America LLC, Palo Alto, CA (US)

(72) Inventors: Hongming Zhang, Mill Creek, WA (US); Xiaoman Pan, Palo Alto, CA (US); Hongwei Wang, Palo Alto, CA (US); Kaixin Ma, Palo Alto, CA (US); Wenhao Yu, Palo Alto, CA (US); Dong Yu, Palo Alto, CA (US)

(73) Assignee: Tencent America LLC, Palo Alto, CA (US)

(21) Appl. No.: 18/905,638

(22) Filed: Oct. 3, 2024

(51) Int. Cl. G06F 9/48

(52) U.S. Cl. CPC G06F 9/4806

(57) ABSTRACT

A method includes receiving, by an autopilot system, a user query; determining, by a perception kernel of the autopilot system, one or more states associated with the user query; executing, by a reasoning kernel of the autopilot system, one or more actions associated with the one or more states; and completing, by the autopilot system, execution of a task associated with the user query.

### FIELD

The disclosure generally relates to dockerized autopilot system.

### BACKGROUND

The concept of an agent, used in reinforcement learning (RL), has been foundational to the field of artificial intelligence. An agent interacts with an environment to learn how to achieve a specific goal by maximizing cumulative rewards. Early work focused on the theoretical underpinnings of RL, such as Markov decision processes and dynamic programming. These methods provided the basis for the development of various RL algorithms.

Key advancements in RL include Q-learning, where agents learn optimal actions through temporal difference learning, and policy gradient methods, allowing agents to directly optimize their policies, beneficial for continuous action spaces. Actor-critic algorithms combine value-based and policy based approaches, improving learning efficiency by using separate structures for the policy (actor) and value function (critic). The integration of deep learning into RL, known as deep reinforcement learning, was a major advancement in recent years. Deep Q-Networks, using neural networks to approximate Q-values, achieved human-level performance in complex tasks like Atari games. Algorithms such as Deep

Deterministic Policy Gradient (DDPG) and Proximal Policy Optimization (PPO) have been pivotal for continuous control tasks, successfully applied in robotics and simulations. These RL methods have enabled significant progress in various domains in recent years, including robotics, healthcare finance, game playing, autonomous driving, and etc.

However, previous assumptions in RL significantly differ from human learning processes, as the human mind is highly complex and capable of learning from a much wider variety of environments. With the recent developments of large language models (LLMs), the concept of agents has evolved beyond simple policy functions in restricted environments. LLM-based agents are able to possess more comprehensive world knowledge, perform more informed actions, and also provide natural language interfaces for human interaction, making them more flexible and explainable. For example, ReAct prompts LLMs to perform dynamic reasoning to create, maintain, and adjust high-level plans for action (reason to act), while also interacting with external environments (e.g., Wikipedia) to incorporate additional information into reasoning (act to reason), thereby achieving superior performance in agent tasks. However, prompting-based agent frameworks still perform poorly in many real-world agent scenarios.

To make LLM-agents task experts, a series of works have focused on collecting expert trajectories from diverse environments and tasks, and training LLM-based agents through behavioral cloning. However, obtaining these expert trajectories is often costly and lacks sufficient exploration. Another line of work involves training LLM-based agents based on environmental feedback using RL methods to align LLMs with agent task objectives. Additionally, some approaches utilize self-improvement, where the model explores the environment to obtain high-reward trajectories and fine-tunes itself based on these trajectories. Although these training strategies have shown promising performance in reasoning, coding, and web tasks, these trained agents remain constrained to their specific tasks, struggle to generalize to general-purpose usage, and are restricted to pre-defined environments.

### SUMMARY

According to an aspect of the disclosure, a method performed by at least one processor, includes receiving, by an autopilot system, a user query; determining, by a perception kernel of the autopilot system, one or more states associated with the user query; executing, by a reasoning kernel of the autopilot system, one or more actions associated with the one or more states; and completing, by the autopilot system, execution of a task associated with the user query.

According to an aspect of the disclosure, an apparatus includes: at least one memory configured to store program code; and at least one processor configured to read the program code and operate as instructed by the program code, the program code including: receiving code configured to cause the at least one processor to receive, by an autopilot system, a user query; determining code configured to cause the at least one processor to determine, by a perception kernel of the autopilot system, one or more states associated with the user query; executing code configured to cause the at least one processor to execute, by a reasoning kernel of the autopilot system, one or more actions associated with the one or more states; and completing code configured to cause the at least one processor to complete, by the autopilot system, execution of a task associated with the user query.

According to an aspect of the disclosure, a non-transitory computer readable medium having instructions stored therein, which when executed by a processor cause the processor to execute a method including: receiving, by an autopilot system, a user query; determining, by a perception kernel of the autopilot system, one or more states associated with the user query; executing, by a reasoning kernel of the autopilot system, one or more actions associated with the one or more states; and completing, by the autopilot system, execution of a task associated with the user query.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is an illustration of an example cognitive kernel system, according to embodiments.

FIG. 4 is an illustration of an example multi-granularity information management system, according to embodiments.

FIG. 5 is a flowchart of an autopilot process, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure are directed to a Cognitive Kernel for implementing an open-sourced agent system towards the goal of general-purpose autopilot systems. Unlike copilot systems, which help humans mainly by answering questions and auto-completion, autopilot systems aim at finishing a task end-to-end independently. To achieve this goal, an autopilot system interacts with all essential information sources of daily tasks including, but not limited to, open web, local documents, long-term memory (user specific), and other domain-specific tools, as needed, and makes decisions accordingly. To create a general-purpose autopilot system, Cognitive Kernel adopts an LLM-centric design, where the LLM is responsible for initiating the interaction with the environment using a combination of atomic actions (e.g., opening a file, going to certain web pages, saving intermediate results to memory, or calling the LLM itself), rather than the widely used environment-centric design, where we have a task-specific environment with predefined available actions and the LLM is only responsible for choosing the correct action based on the given observations. In one or more examples, the Cognitive Kernel is fully dockerized such that one of ordinary skill in the art can deploy an autopilot system efficiently and safely.

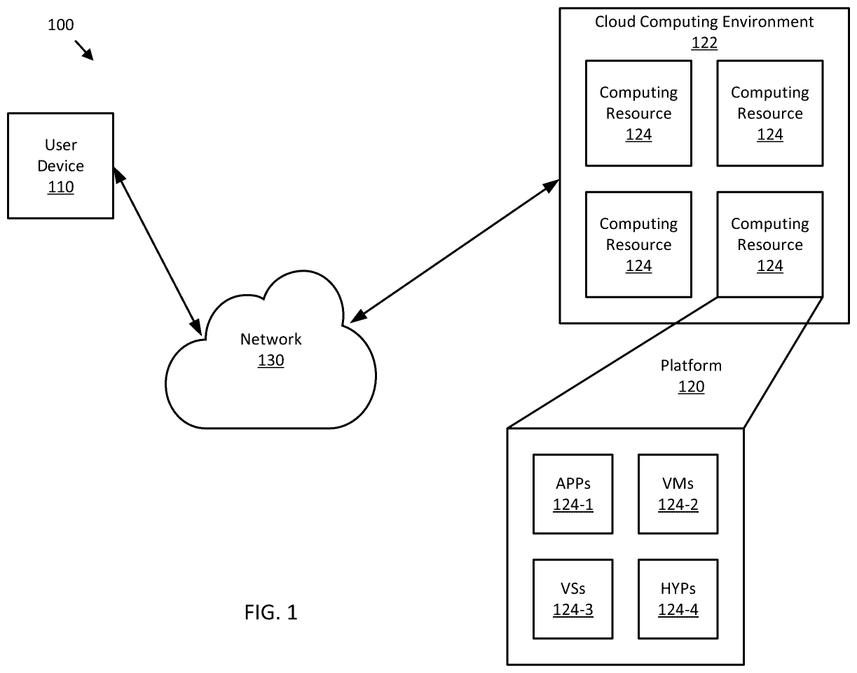

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

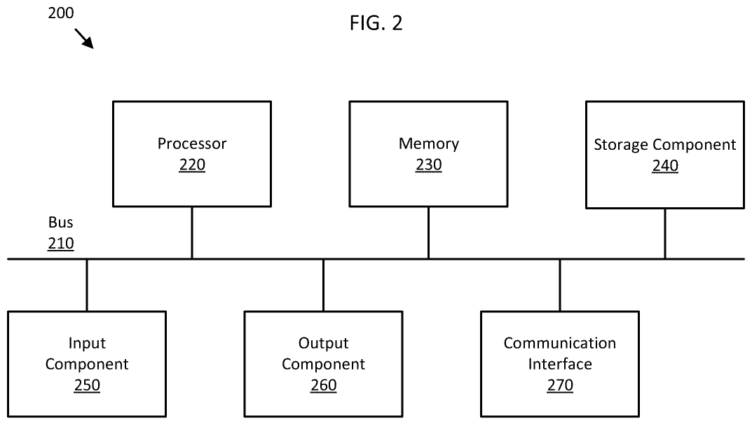

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

Large language models have revolutionized the paradigm of AI applications. Systems in the format of chat models represented by ChatGPT All-in-one 1 and the auto-completion models represented by Microsoft Copilot2 have improved the efficiency of people's daily work. However, these systems mostly serve the role of “Copilot,” where the users are still responsible for most of the work (e.g., planning the overall workflow, asking the correct question, or revising the model output as needed). To further unleash the power of large language models and relieve people from tedious and repetitive jobs, people started to explore “autopilot” systems, where the system is able to take over majority of the responsibilities and users can simply oversight the progress. For example, a Copilot system may be able to recommend a few popular restaurant to the user whereas an Autopilot system can directly make reservations based on the preference provided by the user. Autopilot systems can complete tasks such as inviting reputational researchers as reviewers and booking restaurants based on all employees' preferences without help from human beings. A general-purpose “autopilot” system is one of the ultimate goals of existing efforts on LLM-driven agents.

Autopilot systems are able to complete tasks that Copilot systems are unable to complete. Copilot systems have highly customized workflows, which allows them to specialize in a particular task, but hinders their generalization. For example, an agent system that is equipped with several APIs for accessing a flight booking website may be able to quickly find the desired flight for the user, but it can't book event tickets from a completely different website, or even a flight booking website from another provider. On the other hand, Autopilot systems are equipped with most basic atomic capabilities, which they can flexibily compose to complete complex tasks. For example, for a web agent that is able to perform actions such as click, type and scroll etc. it can essentially accomplish any task that a human user can do in a web browser. Thus, endowing systems with basic atomic abilities is the key towards generalizable autopilot systems.

One example of an automated system is the Turing machine, a mathematical model describing an abstract machine that manipulates symbols based on a table of rules and also a foundation of modern computers. A Turing Machine contains two key concepts: states, which are the set of predefined variables, and transition functions, which are predefined rules describing how a system shall respond to a state. Though the traditional Turing machines cannot directly serve as an “autopilot” system to solve real-world tasks due to the almost infinite space of possible states and transition rules with potential randomness among them, it motivates the two fundamental duties of an “autopilot” system: (1) perceiving and managing essential states; (2) making wise decisions based on the states.

By compressing and modeling vast amounts of world information, LLMs implicitly learn the possible connection between states and thus can serve as a powerful approximation of the transition functions and partially solve the second duty. However, how to perceive and manage the state remains unsolved and challenging. In daily applications, many states are localized such as the remaining tickets of the Super Bowl, private user information, or an in-house code base that the system needs to operate, and thus, beyond the capability of an LLM. How an automated system handles the states distinguishes the Copilot and autopilot AI systems. For a Copilot system, users are responsible for providing localized information. However, for an autopilot system, users would expect the system to sense and monitor all localized states by itself.

Recently, many efforts have been devoted to creating agent systems towards the goal of autopilot systems. For each task such as web browsing, the agent system will create a specific environment to provide the “states,” which typically involves a description of the current state and a set of predefined actions the policy model (e.g., LLM in this scenario) could select from. With that as input, the policy model can generate suitable actions, send them back to the environment for parsing and execution, and wait for the new states. This environment-centric design paradigm simplifies the task and thus, makes building a powerful agent system with untrainable closed-source LLMs such as GPT-4 possible. However, when these agent systems are applied to real applications, there is still a huge gap.

The limitations of the automated systems may be categorized as: (1) State management, and (2) Decision-making. In statement management, a real task often requires complex information from different environments that cannot be predefined. For example, assume the task is inviting all relevant researchers about an uploaded paper to serve as the reviewer. To make wise decisions, the policy model would require state information about the local file, real-time information about the research field, and access to an email system as part of the input. However, one of ordinary skill in the art cannot enumerate all possible tasks in real life and prepare corresponding environments beforehand. In decision-making most existing agent systems employ closed-sourced LLMs such as GPT-4 without any training, which is not ideal due to the gap between training and application. The original training objective is to serve as a chat model rather than the agent scenario. To adopt a fixed LM as the policy model, one must design the prompts to remedy the gap carefully. However, these prompts are neither optimal nor generalizable.

To address these challenges and provide a general-purpose autopilot system, the embodiments of the present disclosure are directed to Cognitive Kernel. Instead of being environment-centric, the embodiments are directed to a system that is model-centric. After receiving a task, instead of passively waiting for state description from a pre-defined environment, the policy model actively perceives the localized state from various environments if needed and takes action accordingly.

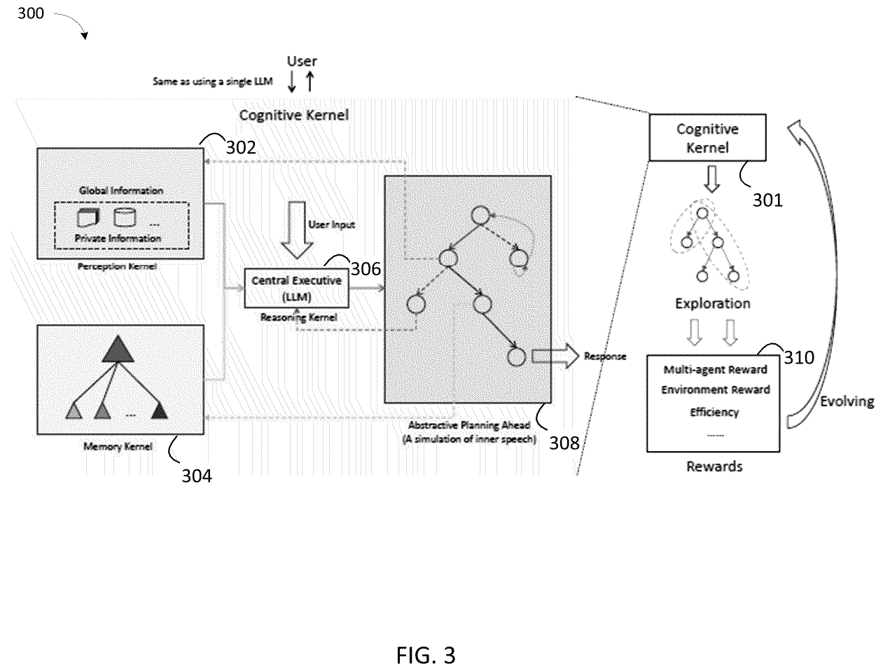

FIG. 3 illustrates an example cognitive kernel system 300, according to embodiments. In one or more examples, the Cognitive Kernel 301 contains three core components: perception kernel 302, memory kernel 304, and reasoning kernel 306, which are responsible for perceiving the current state, caching previous states, and making decisions, respectively. Analogous to the Turing machine, the reasoning kernel 306 is the transition mapping function, the perception kernel 302 is the tool to read the current state, and the memory kernel 304 is the tool to record past states. To simulate how humans acquire information in daily tasks and encourage generalizability, the embodiments design the reasoning kernel 306 to use atomic actions that an ordinary person could do such as, opening a file or clicking a button rather than predefined compound actions such as APIs. To facilitate these features, an object-oriented programming language may be used as the medium. For example, given any states (including both the initial state and middle states with the response from the perception kernel), the reasoning kernel 306 will generate a piece of code that contains self-defined functions, which may be compound actions, and sequential or recursive execution of all actions. For example, the reasoning kernel 306 may generate one or more scripts of code for accessing a file or accessing the web to collect information. Perceiving the state itself can be a challenging task by itself. For example, to plan for a trip to an event, one might need to know the available hotels from an online website, which involves complex interventions with the web. To address this, the three kernels are designed to be intertwined. The output of the reasoning kernel 306 may be provided to Abstractive Planning Ahead 308 to provide a response to a task.

For example, when Cognitive Kernel receives a command from the reasoning kernel 306 to fetch some information about the current state, the perception kernel could also create a more fine-grained task that calls the reasoning kernel 306 again.

Switching from the environment-centric to model-centric design significantly improves the freedom of the system, but it also increases the challenges for the LLM, especially for closed-sourced ones. As understood by one of ordinary skill in the art, most closed-sourced LLMs are often trained to follow instructions to solve self-contained tasks such as answering questions. However, since actions are not predefined as part of the input, the input to the policy model is no longer self-contained. More importantly, real tasks are full of uncertainty, one cannot know the response before he executes the plan, and the model needs to learn from the trials and explorations. To solve this problem, as shown in the right part of FIG. 3, the Cognitive Kernel system 300 contains a continue-evolving mechanism, that supports the system to effectively learn from feedback from users, environments, and the system itself. The feedback for evolving may be through Rewards 310. In one or more examples, the Cognitive Kernel system 300 may be initialized with the open-source model LLama3, and the feedback collected from the system may be used to fine-tune it to adapt to the system design.

The system performance is evaluated in real applications, different from existing agent benchmarks that evaluate models given environments. The systems may be evaluated as a whole with real tasks such as tracking the real-time follower number of a celebrity, sending out an email to invite some researchers, or understanding local files. The following conclusions have been observed through the comparison with leading closed-sourced systems (e.g., ChatGPT website, Kimi website) and opensourced agent systems with various foundation models.

First, closed-source systems typically achieve much better open-sourced environment-centric agent systems with the same-level foundation model such as GPT4-o, which is probably because OpenAI can tune the model better fit their system but open-sourced agent systems can only do that via prompt tuning, which is neither powerful nor generalizable.

Second, due to the higher freedom design, Cognitive Kernel can outperform closed-source systems on tasks that require complex state tracking. For example, for tasks that require web information, ChatGPT can only access Bing search, which is far from sufficient in real applications. By allowing the system to access the real web like humans, Cognitive Kernel can finish more complex tasks.

Third, due to continually evolving models, Cognitive Kernel is stronger than powerful closed-sourced language models and language models such as GPT4-o, which implies no model is perfect, and allowing the system to evolve continually is a crucial design feature for agent systems.

According to one or more embodiments, an autopilot system AS excels at tracking at a current state making wise moves conditional on current states. In one or more examples, the autopilot frame work may be formulated as a 6-tuple AS=( [symbol] ,sₙ, [symbol] ,aₙ,T, [symbol] ), where [symbol] is the set of all possible states,

$${s}_{n}^{′} ∈ 𝒮$$

a the state at timestamp n, . . . [symbol] is the set of possible actions, aₙϵ [symbol] the action at timestamp n, T is the transition matrix, which determines aₙ based on sₙ, [symbol] is the memory component that records s₀ to sₙ₋₁. As understood by one of ordinary skill in the art, in real applications, [symbol] and [symbol] are arbitrarily large to be enumerated by modern machines. Since the size T of is | [symbol] |·| [symbol] |, it is too large to be computed.

To address these limitations and create a practical autopilot system and based on the assumption that large language models such as GPT4 have compressed the world's knowledge, the embodiments of the present disclosure may use an LLM as the policy model F to approximate \tilde{T}. Thus, [symbol] may be reformulated as ( [symbol] ,sₙ, [symbol] ,aₙ,F, [symbol] ), where F is the policy model that can predict aₙ conditional on

$${s}_{n}^{′} .$$

Since LLMs are essentially probabilistic models, this approximation may be viewed as a most likely trajectory based on the trajectory F has seen during the training phase.

A remaining a challenge is the state management. In real applications, other than world knowledge, which can be viewed as a type of global state information, localized state information may be needed to make wise decisions. In one or more examples, the global state information is related to a collection of local state information that may be used to represent a state of a system at a specific time. Even though it may be assumed that the global world knowledge has been stored in F through the huge scale of pre-training, the localized information may still need to be perceived and managed to help F make wise decisions.

In one or more examples, [symbol] may be decoupled as follows:

$$𝒮 = {𝒮}^{g} + {𝒮}^{l} , \qquad Eq . ( 1 )$$

where [symbol] _{global} and [symbol] _{local} represent the global and localized state information, respectively. Similarly, for any state

$${s}_{n}^{′}$$

at timestamp n,

$${s}_{n}^{′}$$

may also be decoupled as follows:

$${s}_{n} = {s}_{n}^{g} + {s}_{n}^{l} . \qquad Eq . ( 2 )$$

In one or more examples, AS may be extended as an 8-tuple

$$〈 {𝒮}^{g} , {𝒮}^{l} , {s}_{n}^{g} , {s}_{n}^{l} , 𝒜 , {a}_{n} , F , ℳ 〉 .$$

As discussed above, a key difference between autopilot systems and copilot systems is that the state information might not be provided, and therefore, needs to be perceived by the system. The variable

$${s}_{n}^{l , o}$$

may be added to denote the observed locate states at each step n.

Empirically,

$${s}_{n}^{l}$$

is the optimal local state that is not easy to obtain, and

$${s}_{n}^{l , o}$$

is the localized state information the autopilot system has and can rely on. At each step n, F will first determine whether

$${s}_{n}^{l , o}$$

is close enough to

$${s}_{n}^{l} ;$$

if it is close enough, F can predict the next action. In one or more examples, a distance between states may be determined using a Euclidean distance. If the Euclidean distance is below a threshold, one state may be considered close to another state. Otherwise, F will activate the perception kernel to perceive more localized states. Each perception task might be an autopilot task requiring further state perception and planning, which may be denoted as Pₖ, where k is the level of the perception tasks.

In one or more examples, AS may be formulated as:

$$\begin{matrix}AS = 〈 {𝒮}^{g} , {𝒮}^{l} , {s}_{n}^{g} , {s}_{n}^{l} , 𝒜 , {a}_{n} , F , ℳ , {P}_{0} 〉 , \\ {P}_{k} = 〈 {𝒮}^{g} , {𝒮}^{l} , {s}_{n}^{g} , {s}_{n}^{l} , 𝒜 , {a}_{n} , F , ℳ , {P}_{k + 1} 〉 .\end{matrix} \qquad Eq . ( 3 )$$

As understood by one of ordinary skill in the art, real applications typically require localized states from two dimensions. The first one is temporal. For example, the states changing from time to time as localized states and those rarely changing as global states may be considered. The second one is spatial, where the private information only several users or systems are allowed to access can be viewed as localized information while others can be considered as global. To further guide the system design, P may be decoupled as PT and PS to represent the perception tasks of acquiring temporary and spatially localized states, respectively.

In one or more examples, a conceptual framework of an autopilot system may be as follows:

$$\begin{matrix}AS = 〈 {𝒮}^{g} , {𝒮}^{l} , {s}_{n}^{g} , {s}_{n}^{l} , 𝒜 , {a}_{n} , F , ℳ , {PT}_{0} , {PK}_{0} 〉 , \\ {PT}_{k} = 〈 {𝒮}^{g} , {𝒮}^{l} , {s}_{n}^{g} , {s}_{n}^{l} , 𝒜 , {a}_{n} , F , ℳ , {PT}_{k + 1} , {PK}_{{k}^{′}} 〉 , \\ {PK}_{k}^{′} = 〈 {𝒮}^{g} , {𝒮}^{l} , {s}_{n}^{g} , {s}_{n}^{l} , 𝒜 , {a}_{n} , F , ℳ , {PT}_{k} , {PK}_{{k}^{′} + 1} 〉 ,\end{matrix} \qquad Eq . ( 4 )$$

where k and k′ denote the depth of PT and PK, respectively.

Accordingly to one or more examples, the Cognitive Kernel may be implemented according to a dockerized implementation for fast and safe deployment. In one or more examples, the Cognitive Kernel system may include six parts: (1) the frontend docker, which handles the visualization system of Cognitive Kernel to multiple users and collects feedback from them; (2) the backend docker, which is the core component of the whole system and provides an isolated environment for the planning code execution and short term state tracking; (3) the web accessing docker, which is written in javascript for the efficient and accurate interaction with the web; (4) the database docker, which handles the memory management of the whole system; (5) the service docker, which handles all requests to the core language models; (6) local file system, which handles the agent character configuration including local files that those agents can access. Dockers may communicate with each other via bi-directional APIs. The only exception may be the local file system. Since Cognitive Kernel may be deployed in a private machine and may run a model-generated code as the planning, Cognitive Kernel may be locked it into a docker, where direct writing into the local file system to minimize the potential risk of harmful code.

Embodiments of the present disclosure include interaction with the open web. Since LLMs only possess stale knowledge, LLMs cannot respond accurately to user queries that require up-to-date information. Consequently, augmenting LLM backbones with additional modules that provide new knowledge (e.g., web search), may be used to fetch relevant information, and then respond to user queries in a retrieval-augmented generation fashion. Such an approach is very effective when the relevant information can be retrieved by the search engine, but it falls short when the user query requires additional interactions with the target website. For example, an user might be interested in “which files are updated in the latest commit of a popular Github repository.” In this case, the system needs to go into the target repo and inspect the details of the latest commit to answer the question, and this process is nearly impossible to complete when using search engine alone. Thus, embodiments of the present disclosure include a web interaction component similar to how human perform web browsing (e.g., performing atomic actions such as click and type in a browser window).

In one or more examples, upon receiving a user query, the reasoning kernel makes the decision whether the current query requires gathering additional information from the web. If yes, a self-contained web browsing instruction is generated, so that any coreference or ambiguity is resolved, and sent to the web server. Within the server, a new browser context is instantiated to host the current browsing session. Different user queries may receive unique and isolated browser context so that we can support multiple users simultaneously with no conflict.

In one or more examples, at every step, an observation of the current web browsing session may be sent to the LLM backbone for predicting the next action. The webpage's accessibility tree may be used as the observation to the agent due to its structural format and conciseness. However, directly feeding the raw accessibility tree to the model is still sub-optimal due to the following challenges: 1) for long websites that contain tens of thousands of elements, the full accessibility tree could easily exceed the input sequence length of the model (e.g. 16K). 2) the accessibility tree may contain a lot of redundant node information, for example, the compound web elements such as gridcells may repeat the same semantic information multiple times along the parent-children hierarchy. Such redundancy not only causes additional computation it may also distract the model when predicting the actions. To address these challenges, the visible elements may be determined from the current viewport and only construct the tree for these elements. The element localization step may be further parallelized to improve efficiency. Node deduplication may be performed heuristically such that only the nodes that contain unique semantic information are kept. Such design provides essential information to the model for action prediction, while significantly reducing the input size, thereby leading to better efficiency.

In one or more examples, similar to how humans browse the web, the atomic actions for the system to interact with a browser may include:
Click: click an element on the webpage;
Type: clear the text content in an element and fill it with new content;
Scroll: scroll up or down of the current viewport;
Goback: go back to the previously browsed page;
Restart: return to the homepage directly and restart the browsing process; and
Stop: summarize the relevant information and sent back to the reasoning kernel.

In one or more examples, only one action is produced at every step, and it is then executed in the browser context to fetch a new observation. For actions that require argument (e.g., target element to interact; click and type) previous works rely on the element's coordinates within the viewport to execute the action. However, using the coordinates may lead to unexpected outcomes. For example, when dropdown menus or gridcells are expanded on certain websites, the coordinates of certain elements may overlap. The agent might decide to click an element behind the dropdown menu, but the execution may actually click on the elements in the dropdown menu. To avoid such scenarios, the element's role and name may be used to pinpoint the target element to interact. This allows precise execution of the action regardless of the current layout of the elements on the webpage. In one or more examples, the model may first generate a chain-of-thought and then generate the final action string.

In one or more examples, since most web browsing tasks require many atomic actions to complete, the agent's trajectory could become very long. This leads to the same issue that the input might exceed the context window size and the model might be distracted by the observation history. To remedy this issue, the agent's trajectory history may be modified such that previous observations are replaced by a special placeholder token and the previous thoughts and actions are kept in full. Since the most relevant information from the webpage is usually mentioned in the agent's chain-of-thought before generating the action, this modified trajectory is able to retain the relevant information from history observations and better guide the model to predict the current action.

In today's information-rich world, effective task completion frequently depends on leveraging contextual information stored in local files. To assist users effectively, an “autopilot” system must be capable of understanding and utilizing this background information accurately. For instance, aiding a financial analyst might involve analyzing financial reports, while supporting legal professionals often requires searching through extensive legal documents to find relevant case law. Additionally, helping a researcher typically includes comprehending the literature they are studying. Standalone LLMs, traditionally trained with simple input-output dynamics or, in the case of recent advancements like GPT-4v, multi-modal inputs, lack the capability to directly process and understand files. However, the content of a file extends beyond plain text; files are self-contained entities with metadata, hierarchical structures, and layouts. Moreover, when humans interact with documents through software like Microsoft Office or Adobe Acrobat Reader, they benefit from numerous clickable functions that facilitate quick operations (e.g., search, count) and navigation (e.g., go to next page). These features, while easily implemented in traditional software, are not readily accessible to LLMs through text-based interactions alone.

Since user queries often involve complex interactions with local files, a sophisticated “autopilot” system is essential to transcend the limitations of a standalone LLM. This system would not only need to process natural language queries efficiently, but also excel in various document-handling skills. By enabling the language model to intelligently interact with user files, it can provide contextually relevant responses and accurately execute user task instructions. To address these needs, the embodiments include a file interaction component to emulate human file-reading abilities, and also to integrate different functionalities to facilitate operations and navigation within user files.

In one or more examples, the system defines atomic actions including:
Operate: Perform specific operations such as counting occurrences, finding specific term, extracting part of input data, and etc.
Navigate: Move to different sections of the file, such as going to the next page, the previous page, or a specific page number.
Search: Perform semantic-based retrieval to find relevant information within the file.
Read: Understand and summarize the content, extracting key information, generating insights or directly answering questions based on the file's content.

In one or more examples, at every step, an observation of the current state of file interaction is sent to the LLM backbone for predicting the next action. The observation includes relevant metadata, the current page or section of the file being viewed, and any results from previous operations (e.g., search results, counts). The observation space may be optimized to include only essential information, reducing redundancy and ensuring that the model focuses on relevant details.

In one or more examples, the system continues the action-observation loop until the user query is fully addressed. Given that many tasks require multiple steps to complete, the model maintains a trajectory of actions and observations. To manage long trajectories, we prioritize retaining the chain-of-thought generated at each step while summarizing or omitting redundant content from the observations. This approach ensures that the model retains relevant historical context without overwhelming the input sequence length.

By integrating these capabilities, the “autopilot” system of the embodiments of the present disclosure can autonomously and effectively support users in their specific environments. This comprehensive interaction with user local files enables the system to handle complex, context-rich tasks, providing accurate and contextually relevant responses that enhance productivity and efficiency.

In one or more examples, the Cognitive Kernel uses a low-level information management system to store essential information and facilitate efficient retrieval for higher-level applications. For example, in the application of long-term memory, a user's dialog history may be processed and stored to support future retrieval and utilization.

Traditional dense retrieval methods typically use documents, fixed-length passage chunks, or sentences as retrieval units—the granularity at which the retrieval corpus is segmented and indexed for inference. However, this granularity is often too broad for the information retriever to pinpoint specific details of interest. Specifically, a document/passage often includes extraneous details that can potentially distract both the retriever and the language model in downstream tasks. Although sentence-level indexing is finer-grained than passage-level indexing, it does not entirely resolve the issue. Sentences can still be complex and compounded, often lacking the necessary contextual information to accurately judge query-document relevance.

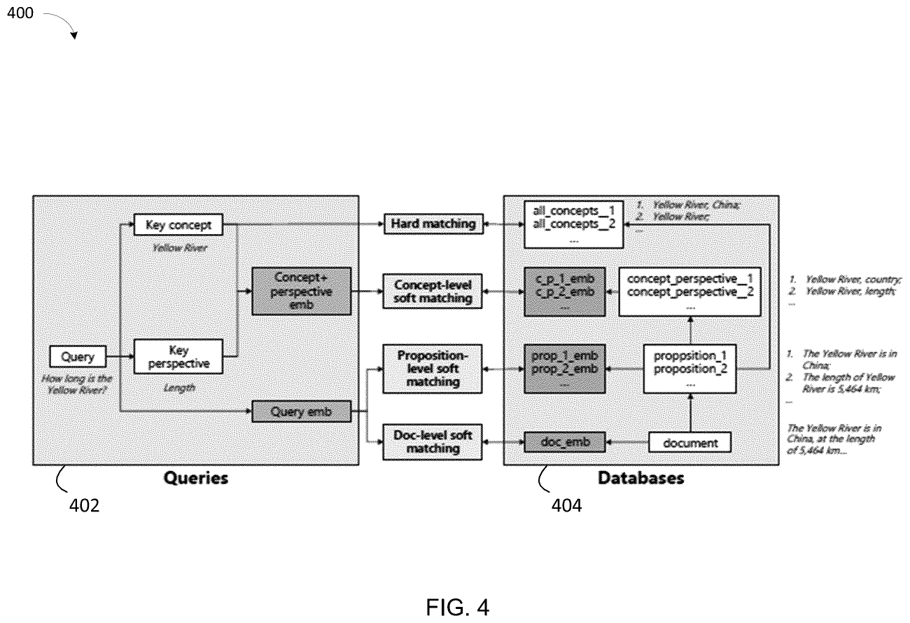

To address the shortcomings of traditional information retrieval methods, a multi-granularity information management system is designed and deployed in Cognitive Kernel. The overall framework of the multi-granularity information management system is illustrated in FIG. 4, which includes example system 400 with two major components: information processing/storage and information retrieval (e.g., queries 402) and information processing/storage (e.g., databases 404).

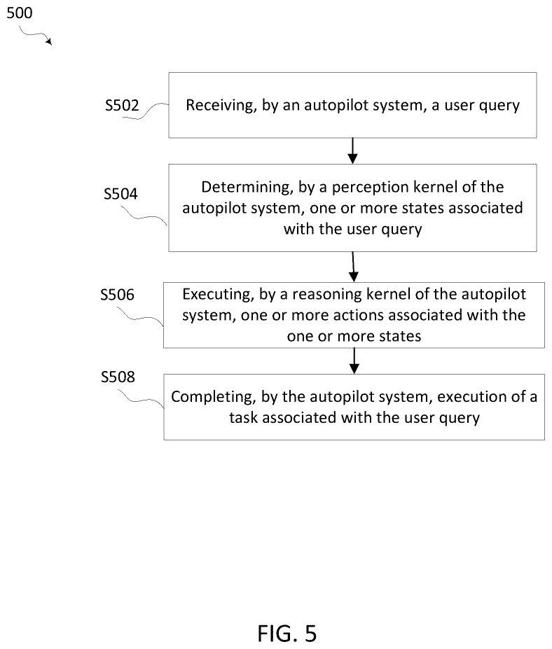

FIG. 5 illustrates a flowchart of an example process 500 for implementing an autopilot process. The process illustrated in FIG. 5 may be implemented by the processor 220.

The process may start at operation S502 where the autopilot system receives a user query. For example, the user query may specify (i) “Book a hotel for me for me in Miami next Saturday,” (ii) “I am vacation in Miami next Saturday and need a flight, hotel, and car rental,” or (iii) “I need to plan my trip to Miami next Saturday.”

The process proceeds to operation S504 where a perception kernel of the autopilot system determines one or more states associated with the user query. The one or more states may be determined by accessing the web or analyzing one or more local files.

The process proceeds to operation S506 where a reasoning kernel of the autopilot system executes one or more actions associated with the one or more states. For example, the actions may include accessing one or more information sources (e.g., web, local files, etc.) to obtain additional information related to the user query. The additional information may be a list of flights and/or hotels available on a particular day. Operations S504 and S506 may be iteratively performed in a loop until enough information is obtained to complete a task.

The process proceeds to operation S508 where the autopilot system completes execution of a task associated with the user query. For example, the autopilot system may complete booking of a flight or hotel based on information that was obtained in the prior operations.

The proposed methods disclosed herein may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor, the method comprising:
receiving, by an autopilot system, a user query;
determining, by a perception kernel of the autopilot system, one or more states associated with the user query;
executing, by a reasoning kernel of the autopilot system, one or more actions associated with the one or more states; and
completing, by the autopilot system, execution of a task associated with the user query.

2. The method according to claim 1, further comprising determining the one or more actions by inputting the one or more states into a large language model (LLM), wherein an output of the LLM corresponds to the one or more actions.

3. The method according to claim 1, wherein the determining the one or more states includes:
generating a web instructions, and
executing the web instruction to open a web browser and execute one or more web searches based on the user query,
wherein at least one state from the one or more states is determined based on the one or more web searches.

4. The method according to claim 3, wherein the executing the web instruction is associated with one or more actions including: click an element on a webpage, type content in an element on the webpage, scroll up or down, go back to a previously browsed page, return to a homepage and restart execution of the one or more web searches, and send information to the reasoning kernel.

5. The method according to claim 1, wherein the determining the one or more states includes:
analyzing one or more local files,
wherein at least one state form the one or more states is determined based on the analyzing the one or more local files.

6. The method according to claim 5, the analyzing the one or more local files is associated with one or more actions including: counting a number of occurrences of a term, finding the term, navigating to different sections in file, performing a semantic-based search, extract information from a file.

7. The method according to claim 1, wherein the autopilot system further includes a memory kernel that stores one or more previous states.

8. The method according to claim 7, wherein at least one state from the one or more states is determined based on the one or more previous states.

9. The method according to claim 1, wherein the autopilot system is an application implemented as a Docker container.

10. The method according to claim 9, wherein the autopilot system includes a front end Docker, a backend Docker, a web accessing Docker, a database Docker, a service Docker, and a local file system.

11. An apparatus comprising:
at least one memory configured to store program code; and
at least one processor configured to read the program code and operate as instructed by the program code, the program code including:
receiving code configured to cause the at least one processor to receive, by an autopilot system, a user query;
determining code configured to cause the at least one processor to determine, by a perception kernel of the autopilot system, one or more states associated with the user query;
executing code configured to cause the at least one processor to execute, by a reasoning kernel of the autopilot system, one or more actions associated with the one or more states; and
completing code configured to cause the at least one processor to complete, by the autopilot system, execution of a task associated with the user query.

12. The apparatus according to claim 11, wherein the determining code further causes the at least one processor to determine the one or more actions by inputting the one or more states into a large language model (LLM), wherein an output of the LLM corresponds to the one or more actions.

13. The apparatus according to claim 11, wherein the determining code further causes the at least one processor to:
generate a web instructions, and
execute the web instruction to open a web browser and execute one or more web searches based on the user query,
wherein at least one state from the one or more states is determined based on the one or more web searches.

14. The apparatus according to claim 13, wherein execution of the web instruction is associated with one or more actions including: click an element on a webpage, type content in an element on the webpage, scroll up or down, go back to a previously browsed page, return to a homepage and restart execution of the one or more web searches, and send information to the reasoning kernel.

15. The apparatus according to claim 11, wherein the determining code further causes the at least one processor to:
analyze one or more local files,
wherein at least one state form the one or more states is determined based on the analyzing the one or more local files.

16. The apparatus according to claim 15, the analyzing the one or more local files is associated with one or more actions including: counting a number of occurrences of a term, finding the term, navigating to different sections in file, performing a semantic-based search, extract information from a file.

17. The apparatus according to claim 11, wherein the autopilot system further includes a memory kernel that stores one or more previous states.

18. The apparatus according to claim 17, wherein at least one state from the one or more states is determined based on the one or more previous states.

19. The apparatus according to claim 11, wherein the autopilot system is an application implemented as a Docker container.

20. A non-transitory computer readable medium having instructions stored therein, which when executed by a processor cause the processor to execute a method comprising:
receiving, by an autopilot system, a user query;
determining, by a perception kernel of the autopilot system, one or more states associated with the user query;
executing, by a reasoning kernel of the autopilot system, one or more actions associated with the one or more states; and
completing, by the autopilot system, execution of a task associated with the user query.
